(19) United States
(12) Patent Application Publication
(10) Pub. No.: US 2014/0066039 A1
(43) Pub. Date: Mar. 6, 2014

(54) Mobile Device Remote Control System and Apparatus, and Road Safety Monitoring Apparatus

(71) Applicant: Chuan Wei Wang, New Taipei City (TW)

(72) Inventor: Chuan Wei Wang, New Taipei City (TW)

(21) Appl. No.: 13/684,523

(22) Filed: Nov. 24, 2012

(30) Foreign Application Priority Data
Sep. 4, 2012 (TW) 101112404

(51) Int. Cl. H04W 4/04

(52) U.S. Cl. CPC H04W 4/046
USPC 455/418

(57) ABSTRACT

The present invention discloses a mobile device remote control system. It includes a remote control unit and a mobile device unit; the mobile device unit for example is a mobile phone. The remote control unit includes a sensor and a wireless transmitter; the sensor is for generating a sensing signal and the wireless transmitter is for transmitting a wireless signal corresponding to the sensing signal to the mobile phone, for controlling the mobile phone to execute a corresponding function. If the mobile phone is replaced by a car computer system, then the system becomes a road safety monitoring apparatus.

### CROSS REFERENCE

The present invention claims priority to TW 101112404, filed on Apr. 9, 2012.

### BACKGROUND OF THE INVENTION

1. Field of Invention

The present invention relates to a mobile device remote control system and a remote control apparatus; particularly, it relates to such a mobile device remote control system which controls a mobile device through wireless transmission such that various types of functions can be performed through the existing functions of the mobile device, and it also relates to a remote control apparatus for use in such a mobile device remote control system. The present invention also relates to a road safety monitoring apparatus.

2. Description of Related Art

Among various mobile devices, mobile phones are the most widely used. A mobile phone can be used not only for verbal communication, but also for many other functions such as browsing the Internet, playing games, navigation, sending and receiving e-mails, etc. In performing the above-mentioned functions, the mobile phone is the controlling side, which controls and executes all the functions. Other mobile devices such as personal digital assistants (PDA), laptop notebooks, or tablet computers, also act as the controlling side in performing similar functions.

However, so far there has not been any development to remote control the mobile phone or the other mobile devices by another device, that is, to use the mobile phone or the other mobile devices as a controlled side to achieve various functions.

The following US patents are provided for reference: U.S. Pat. No. 7,774,155; U.S. Pat. No. 8,102,256; U.S. Pat. No. 7,925,214; U.S. Pat. No. 7,724,826; U.S. Pat. No. 8,077,213; U.S. Pat. No. 8,126,675; US 2012/0028680; U.S. Pat. No. 7,712,365; U.S. Pat. No. 7,987,070; US 2008/0258921; U.S. Pat. No. 7,647,196; U.S. Pat. No. 7,841,967; U.S. Pat. No. 7,343,260; U.S. Pat. No. 7,839,279; U.S. Pat. No. 7,627,451.

### SUMMARY OF THE INVENTION

The present invention provides a mobile device remote control system and a remote control apparatus for use therein.

The present invention also provides a road safety monitoring apparatus.

From one perspective, the present invention provides a mobile device remote control system which comprises a remote control unit and a mobile device unit. The remote control unit includes: a sensor for generating a sensing signal; and a wireless transmitter or a first wireless transceiver for at least transmitting a wireless signal corresponding to the sensing signal. The mobile device unit includes: a wireless receiver or a second wireless transceiver for at least receiving the wireless signal transmitted from the wireless transmitter; a first processor for processing the signal received by the wireless receiver according to an application software; a user interface controlled by the first processor, for interacting with a user; and a first physical or electronic message generating unit controlled by the first processor, for generating a physical message or sending out an electronic message. In some applications, the remote control unit may omit the sensor.

The above-mentioned mobile device remote control system preferably further comprises a controlled unit coupled to the mobile device unit. The controlled unit includes, for example, a display for showing an image generated by the mobile device unit, or a supporting unit for holding the mobile device unit.

From another perspective, the present invention provides a remote control unit for remotely controlling a mobile device unit, the remote control unit comprising: a sensor for generating a sensing signal; and a wireless transmitter for transmitting a wireless signal corresponding to the sensing signal to the mobile device unit such that the mobile device unit is controlled accordingly, wherein the mobile device unit includes a mobile phone, a personal digital assistant, a laptop notebook, or a tablet computer.

In one embodiment, the remote control unit further comprises a second processor for processing the sensing signal, and the transmitted wireless signal corresponds to the processed sensing signal.

In one embodiment, the sensor includes, for example, one or a combination of two or more of the followings: a gyroscope, an accelerometer, a magnetic sensor, a clinical thermometer, a thermometer, a sphygmomanometer, a pressure gauge, a hygrometer, a chemical detector, a saliva detector, an image sensor, a gravity sensor, a microphone, a glucosemeter, a oximeter, an infrared sensor or a carbon monoxide detector.

In one embodiment, the mobile device unit includes a mobile phone and the remote control unit includes a circumaural headphone or an ear-fitting headphone.

In one embodiment, the sensor is for sensing an unusual physical behavior of a user so as to notify the mobile device unit to issue a warning.

In one embodiment, the mobile device unit includes a mobile phone and the sensor is for sensing a physical behavior of a user so as to control the mobile phone to execute a corresponding function.

In one embodiment, the remote control unit is for being placed on or in an article and the wireless transmitter periodically transmits the wireless signal; when the mobile device unit does not receive the periodic wireless signal or when the mobile device unit receives an abnormal wireless signal, it issues a warning.

In one embodiment, the remote control unit includes the first wireless transceiver and the mobile device unit includes the second wireless transceiver, the second wireless transceiver periodically transmitting the wireless signal. The remote control unit includes a second physical or electronic message generating unit. When the remote control unit does not receive the periodic wireless signal or when the remote control unit receives an abnormal wireless signal, the second physical or electronic message generating unit issues a warning.

The so-called waring includes, for example, one or a combination of two or more of the followings: a sound, a vibration, a light shine, an image, a message sent to a personal mailbox, a message sent to a network terminal or an Internet website.

In one embodiment, the sensor is for sensing a condition of a user, a condition of a target object, or a condition of a environment, and the mobile device unit is for showing the condition or an analysis of the condition.

From yet another perspective, the present invention provides a remote control system, comprising: a first remote control unit and a second remote control unit, each of which includes: an inertial sensor for generating a sensing signal; and a wireless transmitter for transmitting a wireless signal corresponding to the sensing signal or receiving the wireless signal transmitted from another one of the two remote control units; wherein the at least one of the two remote control units further includes a physical or electronic message generating unit for generating a physical message or sending out an electronic message.

In one embodiments, the wireless signal transmitted from the at least one of the two remote control units is also received by a mobile device unit such that the mobile device unit is controlled accordingly, wherein the mobile device unit includes a mobile phone, a personal digital assistant, a laptop notebook, or a tablet computer.

From still another perspective, the present invention provides a road safety monitoring apparatus, comprising a remote control unit and a car computer system. The remote control unit includes: a sensor for generating a sensing signal; and a wireless transmitter or a first wireless transceiver for at least transmitting a wireless signal corresponding to the sensing signal. The car computer system includes: a wireless receiver or a second wireless transceiver for at least receiving the wireless signal transmitted from the wireless transmitter; a first processor for processing the signal received by the wireless receiver according to an application software; and a first physical or electronic message generating unit controlled by the first processor, for generating a physical message or sending out an electronic message.

In one embodiment, the remote control unit further includes a second physical or electronic message generating unit, for generating a physical message or sending out an electronic message.

The objectives, technical details, features, and effects of the present invention will be better understood with regard to the detailed description of the embodiments below, with reference to the attached drawings.

### BRIEF DESCRIPTION OF THE DRAWINGS

FIGS. 1-6 shows six embodiments of the present invention.

### DESCRIPTION OF THE PREFERRED EMBODIMENTS

The drawings as referred to throughout the description of the present invention are for illustration only, to show the interrelations between the devices, but not drawn according to actual scale.

Since the mobile phone is the most often used type of mobile devices, the following description will depict the present invention by taking the mobile phone as an example. Certainly, the same concept can also be applied to other types of mobile devices such as personal digital assistants (PDA), laptop notebooks, or tablet computers, etc.

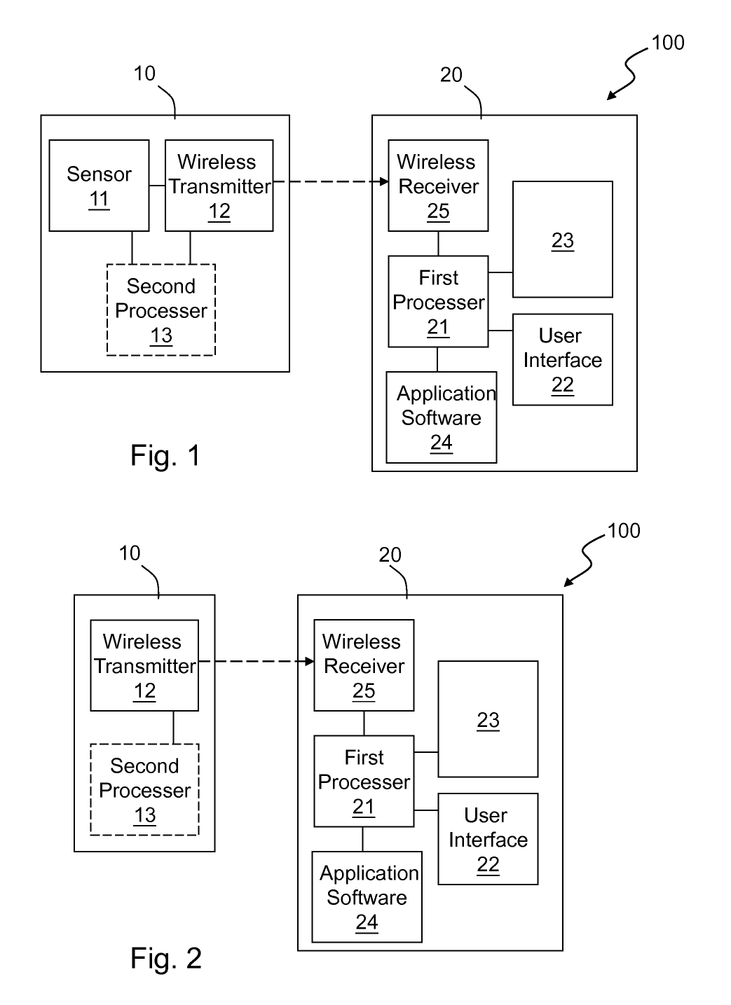

Please refer to FIG. 1. In the first embodiment of the present invention, the mobile device remote control system 100 comprises a remote control unit 10 and a mobile device unit 20. The mobile device unit 20 is, for example, a mobile phone (The mobile device unit 20 is hereinafter referred to simply as the mobile phone to simplify the wording. Certainly the present invention can also be applied to any other mobile device and is not limited to the mobile phone). The remote control unit 10 includes a sensor 11 and a wireless transmitter 12. The sensor 11 is for generating a sensing signal according to a result of its sensing operation. The sensing signal is then transmitted to the mobile phone 20 through the wireless transmitter 12. In addition to the sensor 11 and the wireless transmitter 12, the remote control unit 10 may optionally further includes a processor 13 (not necessarily required). In the case that the remote control unit 10 further includes the processor 13, the processor 13 processes the sensing signal generated by the sensor 11, and the signal transmitted by the wireless transmitter 12 to the mobile phone 20 corresponds to the processed sensing signal. The mobile phone includes a processor 21, a user interface 22, a physical or electronic message generating unit 23, an application software 24 and a wireless receiver 25 (wherein the application software 24 is not a hardware, but it is illustrated in the figure for clarity). The wireless receiver 25 is for receiving the wireless signal transmitted from the wireless transmitter 12. The processor 21 processes the signal received by the wireless receiver 25 according to the application software 24. And, the processor 21 controls the user interface 22 to interact with a user. Also, the processor 21 controls the physical or electronic message generating unit 23 to generate a physical message or an electronic message. The so-called physical message can be, for example but not limited to, a sound, a vibration, a light shine or an image, etc. The so-called electronic message can be, for example but not limited to, a message sent to a personal mailbox, a message sent to a network terminal or an Internet website (e.g., Facebook or other portal websites), etc. A desired function can be executed by cooperation of the processor 13 of the remote control unit 10 and the processor 21 of the mobile device unit 20, or by the processor 21 of the mobile device unit 20 alone.

When the sensor 11 detects any change, or a predetermined type of change as defined according to the application, the remote control unit 10 sends the wireless signal through the wireless transmitter 12 to notify the mobile phone 20 in a wireless manner. As the mobile phone 20 receives the wireless signal from the wireless receiver 25, it generates or takes a corresponding action. The so-called “in a wireless manner” can be, for example but not limited to, communication by Bluetooth, Wi-Fi wireless network, Near Field Communication (NFC) or infrared transmission, etc. The so-called “corresponding action” can be, for example but not limited to, generating a physical or electronic message, such as a sound, a vibration, an image, sending out an electronic message, or executing a predetermined function (e.g., dialing a certain phone number), etc. The first embodiment of the present invention can provide various functions for various applications, such as, for example but limited to, the followings.

1. For example, the sensor 11 can be an inertial sensor and the remote control unit 10 can be made in the shape of, for example but not limited to, a circumaural headphone or an ear-fitting headphone, or it can be integrated as part of a circumaural headphone or ear-fitting headphone. Several examples are given below for the applications of such a structure.

(A) When a driver of a car tends to falling asleep and becoming unconscious, the driver's head will not keep upright and will lean forward, rightward or leftward. The sensor 11 will accordingly generates a signal due to an inertial force. This signal can be judged by, for example, the process 13 to determine whether to issue a warning (the so-called “warning” refers to any types of alerting function, which is regarded as a synonym of “alerting” or “reminding” in the present invention). Or, if the remote control unit 10 does not include the processor 13, the signal can be transmitted to the mobile phone 20 where the processor 21 of the mobile phone 20 operates with the application software 24 to determine whether to issue a warning. If it is determined that a warning should be issued, the physical or electronic message generating unit 23 generates a physical message or an electronic message, which includes, for example, one or a combination of two or more of the followings: issuing a sound, a vibration, a light shine or an image, thus awakening the driver.

(B) When driving, a driver is usually unavailable to dial or answer the phone. However, according to the present invention, as the driver wears the remote control unit 10 on the head or the ear, the driver can control the mobile phone 20 through a physical behavior, which is for example a specific head action (e.g., nodding or shaking head). For example, when the mobile phone 20 is ringing, the driver can decide whether to pick up the mobile phone 20 by nodding the head or shaking the head. Or, in a more preferable embodiment, the application software 24 of the mobile phone 20 can look up and cross reference the incoming phone number in the address book stored in the mobile phone 20, and inform the driver who is the caller through a notifying voice. The driver can therefore decide whether to pick up the mobile phone 20 by nodding the head or shaking the head. On the other hand, when the mobile phone 20 is not receiving an incoming call, the driver can control the mobile phone 20 through a specific head action. For example, nodding the head is indicative of dialing a certain phone number, and shaking the head is indicative of dialing another phone number; or, for another example, nodding and shaking the head can be indicative of executing other functions (e.g., start/stop playing music, up/down changing the music being played, etc.).

2. For example, the sensor 11 can be an inertial sensor, which is, for example, one or a combination of two or more of the followings: a gyroscope, an accelerometer, or a magnetic sensor (e.g., an E-compass). The remote control unit 10 can be made in the form of, for example but not limited to, a small transmitter that can be placed on or in a valuable article (e.g., a handbag, a suit case or a jewel-casket). The remote control unit 10 transmits a wireless signal to the mobile phone 20 in a periodic manner. By this arrangement, if the valuable article is lost but within a sensible range, the user can search and locate the valuable article from the mobile phone 20 by locating where the sensor 11 is. On the other hand, when the mobile phone 20 does not receive the periodic signal for a certain period of time, or when the mobile phone 20 does not receive the periodic signal because of an unpredictable behavior, or when the mobile phone 20 receives an abnormal signal (e.g., when the mobile phone 20 and the remote control unit 10 are still within the sensible range, but the relative distance between them are beyond a certain limit), it issues a warning, which can be, for example, one or a combination of two or more of the followings: a sound, a vibration, a light shine, an image, a message sent to a personal mailbox, a message sent to a network terminal or an Internet website (e.g., Facebook or other portal websites). The message may include, for example but not limited to, the location and the time, thus reminding the user that the valuable article has already been lost. Furthermore, this application example can also be adopted to differentiate the genuine of a valuable good from the fake (only the genuine can transmit a specific wireless signal; or, the genuine and the fake can be differentiated through an authentication code).

As a more detailed example, the remote control unit 10 transmits the wireless signal to the mobile phone 20 in a periodic manner. The wireless signal can be, for example, generated through the user's setup (under this scenario, the wireless signal is not required to be related to the sensing result of the sensor), or generated through the sensing result of the sensor (under this scenario, the wireless signal is related to the sensing result of the sensor). Thus, there are two scenarios which can trigger the mobile phone 20 to issue the warning: a first one is that the mobile phone 20 cannot receive any signal; a second one is that the mobile phone 20 still can receive the signal, but the signal is abnormal. The later scenario is described below.

Assuming that the transmission distance between the wireless transmitter and receiver (e.g., by Bluetooth) is 10 meters, a reference distance within this range can be set up. Assuming that the reference distance between the remote control unit 10 and the mobile phone 20 is set to be 5 meters, when the relative distance between them is longer than 5 meters, the signal is defined as an abnormal signal, although the mobile phone 20 can still receive the signal. The judgment for abnormal signal can be carried out by, for example, the processor 21 or the application software 24. Thus, not only can the loss of a valuable article be detected, but the range where the valuable article is within can also be limited.

In addition, not only can the mobile phone 20 determine whether the remote control unit 10 is lost and whether it is beyond a reference distance, but the remote control unit 10 also can determine whether the mobile phone 20 is lost and whether it is beyond a reference distance. This part will be described in more detail later with regard to the fourth embodiment.

3. For example, the sensor 11 can be one or a combination of two or more of the followings: a clinic thermometer (or a thermometer), a sphygmomanometer, a pressure gauge, a hygrometer, a chemical detector, a glucosemeter, or a oximeter. The present invention is therefore capable of monitoring the physiological condition of a human body or monitoring the condition of a target object. The condition may be analyzed by the application software 24 of the mobile phone 20, and the analysis result can be displayed via the user interface 22.

(A) For example, when the sensor 11 is an infrared thermometer, the remote control unit 10 can be adopted to determine whether the human body has a fever, and the measurement result can be displayed through the mobile phone 20. As compared with the existing infrared thermometer products, this example of the present invention has an advantage that it is not required to dispose an LCD display and associated circuits inside the infrared thermometer, thus significantly decreasing the cost. For another example, when the sensor 11 is a saliva detector, the application software 24 of the mobile phone 20 can analyze the physiological condition of a human body according to the data transmitted from the sensor 11. For yet another example, the sensor 11 can be disposed inside a biochip, which is for example but not limited to disposed inside an animal, so as to trace the physiological condition of the animal, hence enabling the desired experiments or the desired ecology preservation.

(B) For another example, the sensor 11 can be one or a combination of two or more of the followings: a thermometer, a pressure gauge, a hygrometer, an infrared sensor or a carbon monoxide detector, and the mobile phone 20 can display the measurement result, such as the weather or the in-door environment condition.

Please refer to FIG. 2. In the second embodiment of the present invention, the mobile device remote control system 100 comprises a remote control unit 10 and a mobile phone 20. The remote control unit 10 includes the wireless transmitter 12 but does not include the sensor 11. The other parts are substantially the same as the first embodiment. The second embodiment of the present invention can provide various functions for various applications, such as, for example but limited to, the followings.

The remote control unit 10 can be made in form of, for example but not limited to, a small transmitter that can be placed on or in a valuable article (e.g., a handbag, a suit case or a jewel-casket). The remote control unit 10 transmits the wireless signal to the mobile phone 20 in a periodic manner. When the mobile phone 20 does not receive the periodic signal for a certain period of time (e.g., when the mobile phone 20 is not wirelessly connected with the remote control unit 10), it issues a warning, which can be, for example, one or a combination of two or more of the followings: a sound, a vibration, a light shine, an image, a message sent to a personal mailbox, a message sent to a network terminal or Internet website (e.g., Facebook or other portal websites). The message includes, for example but not limited to, the location and the time, thus reminding the user that the valuable article has already been lost. In a different application, the above arrangement can also be adopted to differentiate the genuine of a valuable good from the fake. As compared with the second application example of the first embodiment, this application example does not require a sensor, thus saving the manufacturing cost.

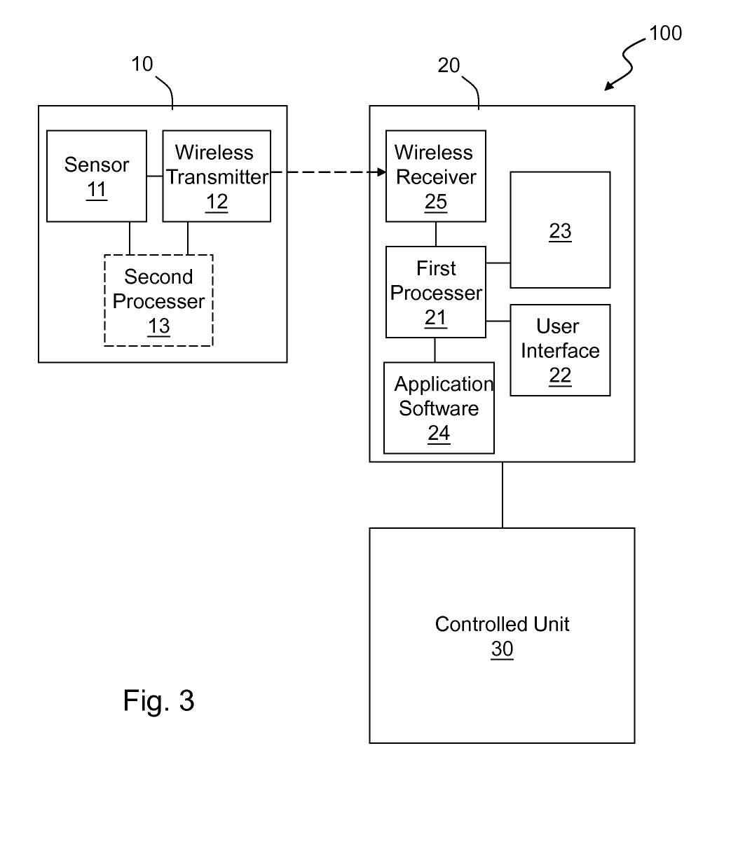

Please refer to FIG. 3. In the third embodiment of the present invention, the mobile device remote control system 100 comprises not only a remote control unit 10 and a mobile phone 20 but also a controlled unit 30 coupled to the mobile phone 20. The term “coupled” as used here includes physical connection or signal communication. The mobile phone is remote controllable by the user via the remote control unit 10. In one example, the controlled unit 30 can be arranged to receive information or command from the mobile phone 20 and generate/take a corresponding action; in another example, the controlled unit 30 can be arranged to receive information or command from some other source and generate/take a corresponding action. The third embodiment of the present invention can provide various functions for various applications, such as, for example but limited to, the followings.

1. The controlled unit 30 is, for example, a display, and the mobile phone 20 is coupled to the display in wired or wireless manner. The user remotely controls the mobile phone 20 through the remote control unit 10. The display receives the information from the mobile phone 20 and display a corresponding image. In this manner, the user can, for example but not limited to, play a game or watch a movie, etc.

2. The controlled unit 30 is, for example, a display, and the mobile phone 20 is coupled to the display in wired or wireless manner. The sensor 11 can be one or a combination of two or more of the followings: a thermometer, a pressure gauge, a hygrometer, an infrared sensor or a carbon monoxide detector. The measurement result, such as the weather or the in-door environment condition, is then transmitted to the display via the mobile phone 20 and is displayed.

3. The controlled unit 30 is, for example, a tripod. The user remotely controls the mobile phone 20 to take a picture through the remote control unit 10. The tripod can be controlled separately, or can be controlled by receiving commands from the mobile phone 20. In the latter case, the user can therefore remotely control the mobile phone 20 through the remote control unit 10 and remotely control the tripod through the mobile phone 20.

4. All the application examples of the first embodiment can also be achieved through the structure of the third embodiment. For example, in the examples (A) and (B) of the first application example of the first embodiment, the controlled unit 30 can be an LCD display in a car, to display a warning or an incoming phone number. In the second application example of the first embodiment, the controlled unit 30 can be a monitor in a showroom of a store. In the examples (A) and (B) of the third application example of the first embodiment, the controlled unit 30 can be a large display, for the user to watch.

5. All the application examples of the second embodiment can also be achieved through the structure of the third embodiment. For example, in the application examples of the second embodiment, the controlled unit 30 can be a monitor in a showroom of a store.

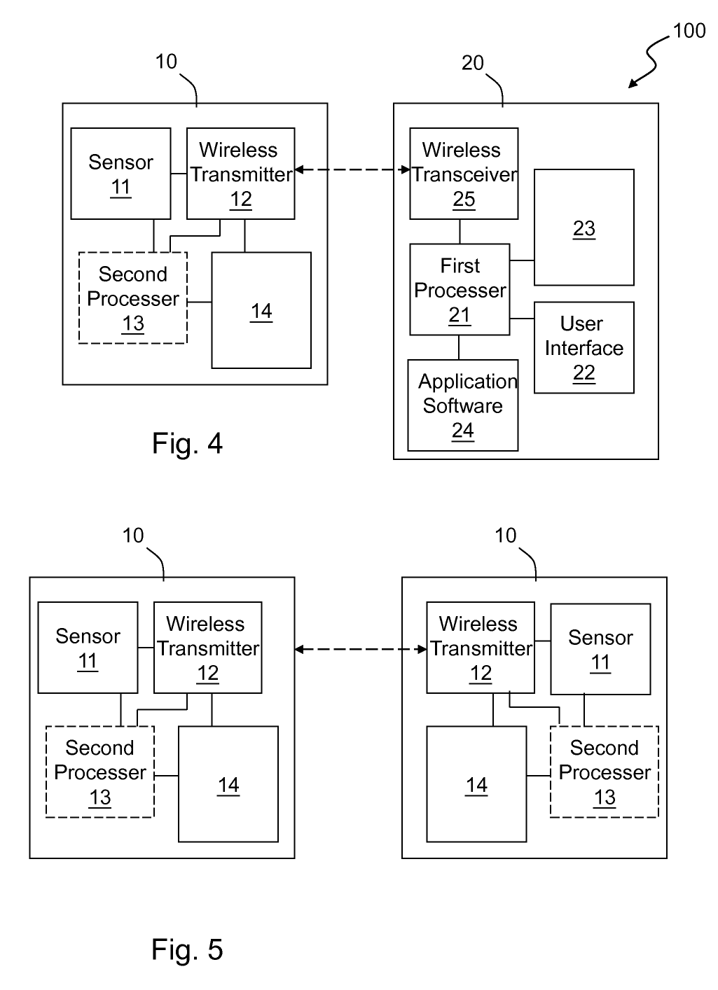

Please refer to FIG. 4. In the fourth embodiment of the present invention, the mobile device remote control system 100 comprises a remote control unit 10 and a mobile phone 20. The remote control unit 10 comprises a sensor 11, a wireless transceiver 12a, a second processor 13 (optionally) and a physical or electronic message generating unit 14. The mobile phone 20 comprises a processor 21, a user interface 22, a physical or electronic message generating unit 23, an application software 24 and a wireless transceiver 25a. The wireless transceiver 12a and the wireless transceiver 25a can mutually communicate with each other. The fourth embodiment of the present invention can provide various functions for various applications, which are similar to those of the first embodiment. In addition, the structure of the fourth embodiment can provide other functions for other applications, such as the followings.

The remote control unit 10 and the mobile phone 20 communicate with each other in a periodic manner. When the remote control unit 10 does not receive the periodic signal for a certain period of time or when the remote control unit 10 does not receive the periodic signal because of an unpredictable behavior, or when the remote control unit 10 receives an abnormal signal (e.g., when the mobile phone 20 and the remote control unit 10 are still within the sensible range, but the relative distance between them is beyond a certain limit), it issues a warning through the physical or electronic message generating unit 14. The warning can be, for example, one or a combination of two or more of the followings: a sound, a vibration, a light shine, an image, a message sent to a personal mailbox, a message sent to a network terminal or Internet website (e.g., Facebook or other portal websites). The message includes, for example but not limited to, the location and the time, thus reminding the user that the valuable article has already been lost. The physical or electronic message generating unit 14 can be directly activated by the wireless transceiver 12a; or, after the wireless transceiver 12a notifies the processor 13, the processor 13 activates the physical or electronic message generating unit 14 to issue a warning. Please refer to the second application example of the first embodiment.

Likewise, in the second embodiment and the third embodiment, the wireless transmitter 12 and the wireless receiver 25 can also be replaced by the wireless transceiver 12a and the wireless transceiver 25a, and the remote control unit 10 is provided with the physical or electronic message generating unit 14, so as to prevent the mobile phone 20 from being lost through bi-directional communication.

Please refer to FIG. 5. The fifth embodiment of the present invention comprises two remote control units 10. Each remote control unit 10 comprises a sensor 11 (optional and can be omitted), a wireless transceiver 12a, a second processor 13 (optional and can be omitted) and a physical or electronic message generating unit 14. The two wireless transceivers 12a, 12a can mutually communicate with each other. The fifth embodiment of the present invention can provide various functions for various applications. For example, one of the remote control units 10 can be placed on or in a valuable article (e.g., a handbag, a suit case or a jewel-casket), while the other one of the remote control units 10 can be disposed at any suitable location to monitor the valuable article. For another example, one of the remote control units 10 can sense whether a driver is in an unusual condition, while the other one of the remote control units 10 can issue a warning. In the above-mentioned examples, while one of the remote control units 10 comprises a physical or electronic message generating unit 14, the other one of the remote control units 10 may omit the physical or electronic message generating unit 14.

In addition, similar to the second application example of the first embodiment and the fourth embodiment, it can be arranged for the remote control unit 10 to issue the warning under two scenarios: one is that the remote control unit 10 cannot receive any signal; the other one is that the remote control unit 10 still can receive the signal, but the signal is abnormal.

The fifth embodiment shown in FIG. 5 is capable of monitoring an abnormal condition bi-directionally. For example, the sensors 11 can be inertial sensors. While one of the remote control units 10 is in a still status and the other one of the remote control units 10 is moving, the sensor 11 of the still remote control unit 10 will not sense any change of itself while the sensor 11 of the moving remote control unit 10 will sense a change of itself. Thus, the difference can trigger one or both of the remote control units 10 to issue a warning. One application for the above arrangement is that, for example, one of the remote control units 10 can be attached (e.g., placed or adhered) on or in a valuable article (e.g., a handbag, a suit case or a jewel-casket), and the other one of the remote control units 10 can be carried by a user (e.g., hand-held, worn on, or put in the pocket). When the user leaves his/her seat and forgets to carry the valuable article with him/her (in this case the user is moving), or when the valuable article is stolen (in this case the valuable article is moving), a warning is issued to alert the user. In other words, one or both of the two remote control units is being monitored and the monitored control unit is determined normal or abnormal with reference to a status sensed by the inertial sensor of the other control unit.

The above-mentioned “still status” can be an absolute still status or a relative still status. In the absolute still status, only the sensor 11 of one of the two remote control units 10 senses a change of itself. In the relative still status, although the sensors 11 of both remote control units 10 sense changes, an abnormal condition can still be identified according to whether one of the changes is a non-inertial change. For example, the user may be transported by a high speed vehicle such as Mass Rapid Transportation (MRT) or High Speed Rail (HSR) where the user and the valuable article he/she carries are both moving inertially in a horizontal direction. If the valuable article has a movement toward another direction or has an angular rotation, and such movement or rotation is not detected by the sensor 11 of the remote control unit 10 carried by the user, then it can be determined abnormal, which may indicate that the valuable article is stolen. For another example, if the user forgets to bring along the valuable article when he/she gets up from the seat, the sensor 11 the remote control unit 10 carried by of the user will detect a change which is not detected by the sensor 11 of the remote control unit 10 attached to the valuable article, thus an abnormal condition is also found. If the user and the valuable article both move or rotate in the same direction, then both sensors will detect similar changes, and it can determined normal. For yet another example, if the valuable article falls down, the sensor 11 of the remote control unit 10 attached to the valuable article will not detect the gravity during the falling process, but the sensor 11 of the remote control unit 10 carried by the user will detect the gravity, and it can determined abnormal.

The changes detected by two sensors 11 can be compared with each other, and a threshold of the difference can be set. When the difference between the changes is lower than the difference threshold, the changes are regarded as similar, which is normal. When the difference between the signal changes is higher than the difference threshold, the changes are regarded as abnormal. (When the difference between the changes is equal to the difference threshold, the signal changes can be regarded as normal or abnormal depending on the design).

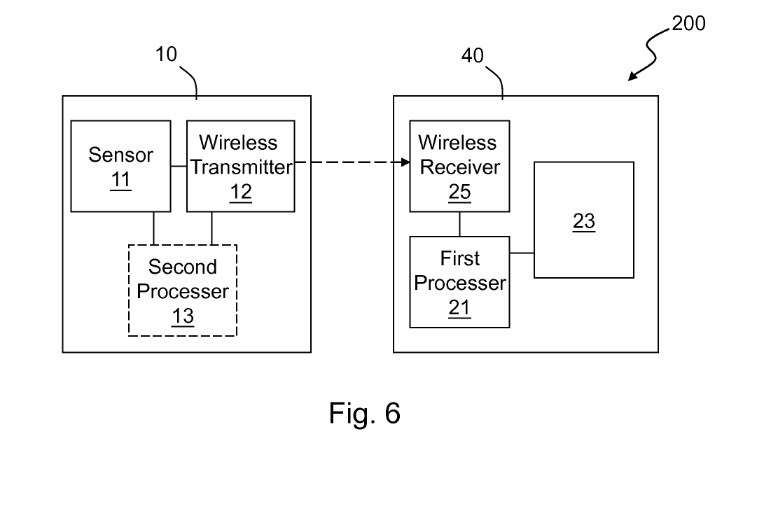

Please refer to FIG. 6, which is the sixth embodiment of the present invention. This embodiment is a road safety monitoring apparatus 200 and is similar to the first embodiment, but is different in that this embodiment replaces the mobile phone 20 by a car computer system 40. The remote control unit 10 includes a sensor 11, a wireless transmitter 12, and a second processor 13 (optional and can be omitted). The car computer system 40 includes a processor 21, a physical or electronic message generating unit 23 and a wireless receiver 25. The sixth embodiment can provide various functions for various applications. For example, similar to the first application example (A) of the first embodiment, the sixth embodiment can issue a warning through the physical or electronic message generating unit 23 if the driver is in an abnormal condition. Or, similar to the first application example (B) of the first embodiment, the driver can control the car computer system 40 through a certain head action, for example to start/stop playing music, or to change the music being played, etc.

In the sixth embodiment, the wireless transmitter 12 and the wireless receiver 25 can be replaced by the wireless transceiver 12a and the wireless transceiver 25a, and the remote control unit 10 can include a physical or electronic message generating unit 14, to alert a user if the car is being stolen or lost, or to help the user in finding and locating his/her car, etc.

In all of the above embodiments, the mobile device such as the mobile phone, or the car computer system, is preferably programmable at least for some of its functions. In one example, a user may often need to turn ON and turn OFF (activate and deactivate) Bluetooth communication of his/her mobile phone (or other types of mobile devices). According to the present invention, the Bluetooth communication may be programmable; that is, the user can pre-set the ON time and OFF time of the Bluetooth communication, in a way similar to programming an alarm clock. Certainly, the communication function is not limited to Bluetooth which is only one example, but can be any other communication function.

The present invention has been described in considerable detail with reference to certain preferred embodiments thereof. It should be understood that the description is for illustrative purpose, not for limiting the scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, the physical behavior of the user is not limited to a drastic action. In some occasions, for example when the user is a handicapped, the sensor 11 can be used to detect a fine movement such as the user's eyelid movement or facial skin movement. For another example, the sensor 11 can be other types of sensors which are not specifically listed in the above, such as an image sensor, a gravity sensor or an acoustic sensor, etc. For yet another example, in the third application example of the third embodiment, the controlled unit 30 is not limited to the tripod, but can also be any other type of support devices. In view of the foregoing, the spirit of the present invention should cover all such and other modifications and variations, which should be interpreted to fall within the scope of the following claims and their equivalents.

What is claimed is:

1. A mobile device remote control system, comprising:
a remote control unit, which includes:
a sensor for generating a sensing signal; and
a wireless transmitter or a first wireless transceiver for at least transmitting a wireless signal corresponding to the sensing signal; and
a mobile device unit, which includes:
a wireless receiver or a second wireless transceiver for at least receiving the wireless signal transmitted from the wireless transmitter;
a first processor for processing the signal received by the wireless receiver according to an application software;
a user interface controlled by the first processor, for interacting with a user; and
a first physical or electronic message generating unit controlled by the first processor, for generating a physical message or sending out an electronic message.

2. The mobile device remote control system of claim 1, further comprising a controlled unit coupled to the mobile device unit.

3. The mobile device remote control system of claim 2, wherein the controlled unit is a display for showing an image generated by the mobile device unit or a supporting unit for holding the mobile device unit.

4. The mobile device remote control system of claim 1, wherein the remote control unit further comprises a second processor for processing the sensing signal and the transmitted wireless signal corresponds to the processed sensing signal.

5. The mobile device remote control system of claim 1, wherein the sensor includes one or a combination of two or more of the followings: a gyroscope, an accelerometer, a magnetic sensor, a clinical thermometer, a thermometer, a sphygmomanometer, a pressure gauge, a hygrometer, a chemical detector, a saliva detector, an image sensor, a gravity sensor, a microphone, a glucosemeter, a oximeter, an infrared sensor or a carbon monoxide detector.

6. The mobile device remote control system of claim 1, wherein the mobile device unit includes a mobile phone and the remote control unit includes a circumaural headphone or an ear-fitting headphone.

7. The mobile device remote control system of claim 1, wherein the sensor is for sensing an unusual physical behavior of a user, whereby the mobile device unit is controlled to issue a warning.

8. The mobile device remote control system of claim 1, wherein the mobile device unit includes a mobile phone and the sensor is for sensing a physical behavior of a user, whereby the mobile phone is controlled to execute a corresponding function.

9. The mobile device remote control system of claim 1, wherein the remote control unit is for being placed on or in an article and the wireless transmitter periodically transmits the wireless signal; and wherein when the mobile device unit does not receive the periodic wireless signal or when the mobile device unit receives an abnormal wireless signal, the mobile device unit issues a warning.

10. The mobile device remote control system of claim 9, wherein the warning includes one or a combination of two or more of the followings: a sound, a vibration, a light shine, an image, a message sent to a personal mailbox, or a message sent to a network terminal or an Internet website.

11. The mobile device remote control system of claim 1, wherein the remote control unit includes the first wireless transceiver and the mobile device unit includes the second wireless transceiver, the second wireless transceiver periodically transmitting a wireless signal; and the remote control unit includes a second physical or electronic message generating unit; wherein when the remote control unit does not receive the periodic wireless signal or when the remote control unit receives an abnormal wireless signal, the second physical or electronic message generating unit issues a warning.

12. The mobile device remote control system of claim 11, wherein the warning includes one or a combination of two or more of the followings: a sound, a vibration, a light shine, an image, a message sent to a personal mailbox, a message sent to a network terminal or an Internet website.

13. The mobile device remote control system of claim 1, wherein the sensor is for sensing a condition of a user, a condition of a target object, or a condition of an environment, and the mobile device unit is for showing the condition or an analysis of the condition.

14. The mobile device remote control system of claim 1, wherein the mobile device unit includes a mobile phone, a personal digital assistant, a laptop notebook, or a tablet computer.

15. A remote control unit for remotely controlling a mobile device unit, the remote control unit comprising:
a sensor for generating a sensing signal; and
a wireless transmitter for transmitting a wireless signal corresponding to the sensing signal to the mobile device unit such that the mobile device unit is controlled accordingly,
wherein the mobile device unit includes a mobile phone, a personal digital assistant, a laptop notebook, or a tablet computer.

16. The remote control unit of claim 15, further comprising a processor for processing the sensing signal, wherein the transmitted wireless signal corresponds to the processed sensing signal.

17. The remote control unit of claim 15, wherein the sensor includes one or a combination of two or more of the followings: a gyroscope, an accelerometer, a magnetic sensor, a clinical thermometer, a thermometer, a sphygmomanometer, a pressure gauge, a hygrometer, a chemical detector, a saliva detector, an image sensor, a gravity sensor, a microphone, a glucosemeter, a oximeter, an infrared sensor or a carbon monoxide detector.

18. The remote control unit of claim 15, wherein the mobile device unit includes a mobile phone and the remote control unit includes a circumaural headphone or an ear-fitting headphone.

19. The remote control unit of claim 15, wherein the sensor is for sensing an unusual physical behavior of a user so as to notify the mobile device unit.

20. The remote control unit of claim 15, wherein the mobile device unit includes a mobile phone and the sensor is for sensing a physical behavior of a user so as to control the mobile phone to execute a corresponding function.

21. The remote control unit of claim 15, wherein the remote control unit is for being placed on or in an article and the wireless transmitter periodically transmits the wireless signal; and wherein when the mobile device unit does not receive the periodic wireless signal or when the mobile device unit receives an abnormal wireless signal, the mobile device unit issues a warning.

22. The remote control unit of claim 15, wherein the sensor is for sensing a condition of a user, a condition of a target object, or a condition of an environment, and the mobile device unit is for showing the condition or an analysis of the condition.

23. A remote control system, comprising:
a first remote control unit and a second remote control unit, each of which includes:
an inertial sensor for generating a sensing signal; and
a wireless transmitter for transmitting a wireless signal corresponding to the sensing signal or receiving the wireless signal transmitted from another one of the two remote control units;
wherein at least one of the two remote control units further includes a physical or electronic message generating unit for generating a physical message or sending out an electronic message.

24. The remote control system of claim 23, wherein the wireless signal transmitted from the at least one of the two remote control units is also received by a mobile device unit such that the mobile device unit is controlled accordingly, and wherein the mobile device unit includes a mobile phone, a personal digital assistant, a laptop notebook, or a tablet computer.

25. The remote control system of claim 23, wherein the inertial sensor includes one or a combination of two or more of the followings: a gyroscope, an accelerometer or a magnetic sensor.

26. The remote control system of claim 23, wherein when the inertial sensors of both of the first remote control unit and the second remote control unit do not sense a change or when both sense changes which are similar, it is determined normal; and if one of the inertial sensors senses a change which is not sensed or is dissimilar to a change sensed by another one of the inertial sensors, it is determined abnormal.

27. The remote control system of claim 23, wherein one of the two remote control units is attached to an article while another one of the two remote control units is carried by a user.

28. The remote control system of claim 23, wherein one of the two remote control units is being monitored and the monitored control unit is determined normal or abnormal with reference to a status sensed by the inertial sensor of the other control unit.

29. The remote control system of claim 23, wherein at least one of the two remote control units include a communication function which can be turned ON and turned OFF, wherein a turn-ON or turn-OFF time of the communication function is programmable.
